(19) United States
(12) Patent Application Publication
(10) Pub. No.: US 2007/0257842 A1
(43) Pub. Date: Nov. 8, 2007

(54) Coupled-fed antenna device

(75) Inventor: Wen Jen Tseng, Kaohsiung City (TW)

Correspondence Address: TROXELL LAW OFFICE PLLC, SUITE 1404, 5205 LEESBURG PIKE, FALLS CHURCH, VA, 22041, US

(73) Assignee: Air2U Inc.

(21) Appl. No.: 11/415,249

(22) Filed: May 2, 2006

(51) Int. Cl. H01Q 1/38

(52) U.S. Cl. 343/700 MS; 343/702

(57) ABSTRACT

A coupled-fed antenna device comprising a substrate, a signal source, a ground plane, a radiation conductor, and a coupling feedline is disclosed. The substrate has at least a first surface and a second surface, and the signal source is disposed on the first surface. The ground plane is electrically grounded and covers at least partial area on the second surface of substrate. The radiation conductor is disposed on the second surface of substrate and connected to the ground plane. The coupling feedline consists of a first feedline connected to the signal source and a second feedline connected to the radiation conductor. The real part of the antenna input impedance may be adjusted by shifting the attachment point between the second feedline and radiation conductor. The first feedline and the second feedline are coupled together by a coupling element. The imaginary part of the antenna input impedance may be adjusted by changing the input impedance of an open stub of the coupling element.

### BACKGROUND OF INVENTION

1. Field of the Invention

The present invention relates to a kind of coupled-fed antenna device, more particularly a coupled-fed antenna device where its imaginary part of input impedance may be adjusted by disposing a coupling element serially connected to the signal feedline of inverted F antenna.

2. Description of the Prior Art

The application of wireless communication technology by the military and the private industry is becoming more extensive in recent years. It is also gaining popularity in personal devices. The trends of the future is to equip all electronic devices with the function of wireless communication, for example, computer peripherals, such as wireless mouse, wireless keyboard, and wireless network, or consumer electronics, such as mobile phone, PDA with mobile phone function, bluetooth earpiece, and bluetooth MP3, or even home appliance, such as refrigerator and television.

In products with wireless communication function nowadays, typically a printed antenna device is configured on the system -circuit board disposed with a plurality of electronic circuits for generating wireless signals to provide the function of wireless communication. Such antenna device is designed with a radiation conductor of specific shape and length to enhance the ability to transmit or receive wireless signals of predetermined frequency. Generally when integrating antenna devices to the system circuit board, the designer usually reserves space for an impedance matching circuit on the circuit board to compensate the input impedance of the antenna.

Referring to FIGS. 1 and 2, FIG. 1 shows a conventional inverted F antenna (IFA) 10, and FIG. 2 is a drawing of an input impedance equivalent circuit of the inverted F antenna 10 shown in FIG. 1.

As shown in FIG. 1, one end of the radiation conductor 12 on the substrate 11 of the antenna 10 is directly connected to an attachment point 121 on ground plane 13. The signal source 14 for producing wireless signals is directly connected to an attachment point 122 on radiation conductor 12 via a feedline 15. As such, signals produced by signal source 14 can be transferred to the radiation conductor 12 via feedline 15 and radiate to a free space. At this time, the input impedance of inverted F antenna 10 is Za (Za=Rz+jXa, Ra is the real part of impedance and Xa is the imaginary part of impedance), and its equivalent circuit is as shown in FIG. 2. When attachment point 122 moves toward attachment point 121, the real part of input impedance of antenna 10 becomes smaller; when attachment point 122 moves in the opposite direction, the real part of impedance of antenna 10 becomes bigger. Thus in the design of inverted F antenna 10, the real part impedance matching between antenna 10 and system circuit is controlled by adjusting the position of attachment point 122. Such approach however produces limited effect on the imaginary part of antenna impedance. The impedance of wireless communication system circuit is generally 50Ω. Circuit designer can find an attachment point 122 to keep the real part of antenna impedance Ra at 50Ω. But usually a circuit board needs to reserve a space for matching circuit to increase the bandwidth by eliminating the effect of the imaginary part of antenna impedance Xa. The cost of matching circuit is relatively high and takes the space of circuit board, thereby leaving room for further improvement.

### SUMMARY OF INVENTION

The first object of the present invention is to provide a coupled-fed antenna device, characterized in which the antenna device itself provides the compensatory function for both the real part and the imaginary part of input impedance without the need to reserve space for matching circuit on the system circuit board.

The second object of the present invention is to provide a coupled-fed antenna device, characterized in which a coupling element is serially connected to the signal feedline of antenna device to adjust the imaginary part of its input impedance, and the real part of input impedance is adjusted by shifting the position of attachment point between feedline and radiation conductor of antenna device.

To achieve the aforesaid objects, the present invention provides a coupled-fed antenna device comprising a substrate, a signal source, a ground plane, a radiation conductor and a coupling feedline. The substrate has at least a first surface and a second surface which are defined with a first direction and a second direction perpendicular to each other thereon. The signal source is disposed on the first surface to provide wireless signals. The ground plane is electrically grounded and covers at least a part of the area on the second surface of substrate. The radiation conductor is disposed on the second surface of substrate and extends from the ground plane a predetermined first length generally towards the first direction and then turns generally towards the second direction to extend a predetermined second length to form substantially an inverted F antenna configuration. The coupling feedline connects the signal source and the radiation conductor, and consists of at least a first feedline and a second feedline coupled together without contacting each other. One end of the second feedline is connected to a predetermined attachment point on the radiation conductor. The real part of the input impedance of antenna may be adjusted by shifting the attachment point. The first feedline and the second feedline are coupled together by a coupling element, which is substantially serially connected between the signal source and said attachment point. Thus the imaginary part of the antenna input impedance may be adjusted by changing the input impedance of an open stub of the coupling element. As such, a mechanism for adjusting the “real part of impedance” and “imaginary part of impedance” is disposed directly on the antenna by means of “serial connection” without disposing a matching circuit on the system circuit board to eliminate the effect of “imaginary part impedance”, thereby offering the advantages of simpler design, lower cost and space saving.

### BRIEF DESCRIPTION OF THE DRAWINGS

The details of the present invention will be more readily understood from a detailed description of the preferred embodiments taken in conjunction with the following Figures.

FIG. 1 is a diagram of a conventional inverted F antenna (IFA).

FIG. 2 is a diagram showing the input impedance equivalent circuit of a conventional inverted F antenna shown in FIG. 1.

FIG. 3 is a perspective view of a coupled-fed antenna according to a first embodiment of the invention.

FIG. 4 is a diagram showing the input impedance equivalent circuit of the inverted F antenna according to the invention shown in FIG. 3.

FIG. 5 is a perspective view of a coupled-fed antenna according to a second embodiment of the invention.

FIG. 6 is a perspective view of a coupled-fed antenna according to a third embodiment of the invention.

FIG. 7 is a perspective view of a coupled-fed antenna according to a fourth embodiment of the invention.

FIG. 8 is a perspective view of a coupled-fed antenna according to a fifth embodiment of the invention.

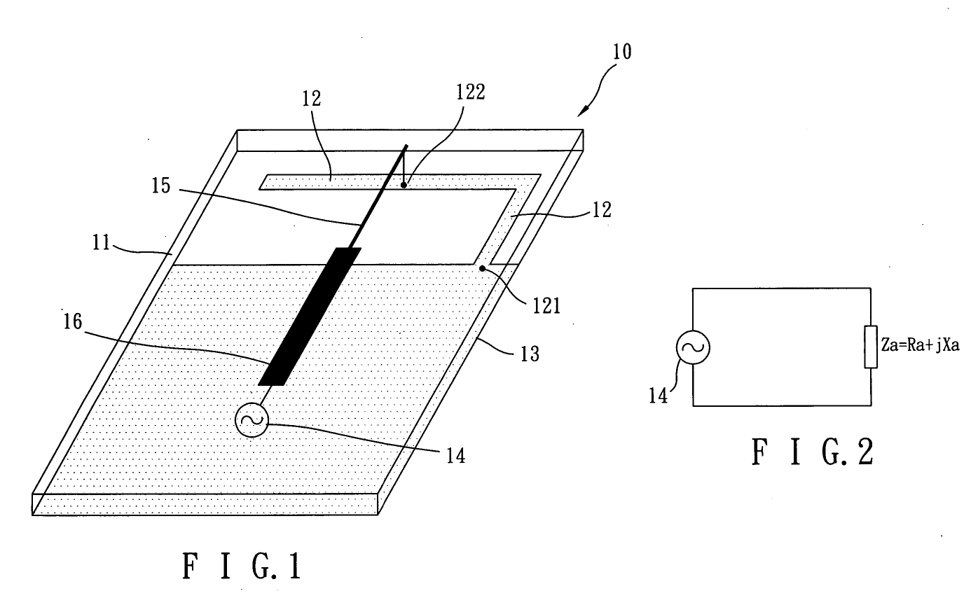

### DETAILED DESCRIPTION

FIG. 3 shows a perspective view of a coupled-fed antenna 20 according to a first embodiment of the invention. In the first embodiment, the coupled-fed antenna 20 comprises: a substrate 21, a signal source 22, a ground plane 23, a radiation conductor 24, and a coupling feedline 25.

The substrate 21 is a flat panel made of dielectric material having at least a first surface 211 and a second surface 212. The surfaces 211, 212 of substrate 21 are respectively defined with a first direction 91 and a second direction 92 perpendicular to each other thereon. The first surface 211 and the second surface 212 are substantially the top surface and bottom surface of substrate 21, or an intermediate layer.

The signal source 22 is disposed on the first surface 211 of substrate 21 to provide high frequency signal for wireless communication. The signal source 22 consists of a plurality of electronic circuits (or integrated circuits) for generating wireless signals. Given that the circuit design of signal source 22 is not a technical feature of the invention, to which the prior art may apply, its detailed constitution will not be elaborated and this element is indicated only with a symbol 22.

The ground plane 23 is electrically grounded and covers at least a partial area on the second surface 212 of substrate 21. More particularly the part of second surface 212 with projection in the direction perpendicular to the first surface 211 that covers extensively the vicinities of source signal 22 is covered by the ground plane 23. In other words, the projection of signal source 22 in the direction perpendicular to the first surface 211 is covered by the ground plane 23 on second surface 212.

The radiation conductor 24 is disposed on the second surface 212 of substrate 21. In the first embodiment, one end of the radiation conductor 24 extends a predetermined first length from an attachment point 241 on the edge of ground plane 23 generally towards the first direction 91 and then turns generally towards the second direction 92 and extends a predetermined second length to form a L-shaped long strip structure.

The coupling feedline 25 connects the signal source 22 and radiation conductor 24 and consists of: a first feedline 251, a second feedline 252 and a coupling element 253. In the first embodiment, the first feedline 251, the second feedline 252 and the coupling element 253 are all disposed on the first surface 211, and their projections in the direction perpendicular to the first surface 211 are not covered by the ground plane 23 on second surface 212. The terminal end of first feedline 251 is connected to the signal source 22 via a signal transmission line 26. The front end of second feedline 252 is connected to a predetermined attachment point 242 on radiation conductor 24 through a via 27. The same as prior art, the antenna device 20 of the invention adjusts and matches the real part of its input impedance by moving the position of attachment point 242. Also, because the projections of coupling feedline 25 and radiation conductor 24 in the -direction perpendicular to the first surface 211 exhibits an inverted F structure, the antenna device 20 as shown in FIG. 3 is commonly called inverted F antenna.

The first feedline 251 and the second feedline 252 are coupled together by coupling element 253 without contacting each other. Thus the coupling element 253 is substantially “serially connected” between the signal source 22 and the predetermined attachment point 242. In the first embodiment of the invention as shown in FIG. 3, the coupling element 253 consists of two short coupled lines 2531, 2532 adjoining and parallel to each other. Short coupled line 2531 is connected to the front of first feedline 251, and short coupled line 2532 is connected to the end of second feedline 252. The two short coupled lines 2531, 2532 can have the same or different length and width.

The coupling element 253 can be taken as an open stub. The input impedance of open stub at high frequency is generally expressed as Zs, where Zs=j(−Zo×cot ⊕l)=jXs; Xs=−Zo×cot βl. Its input port is located at where indicated as (f′, f) on FIG. 3. Zo is the characteristic impedance of open stub, β is the propagation constant of electromagnetic wave on open stub, l is the length of open stub, and the input impedance of open stub has only an imaginary part.

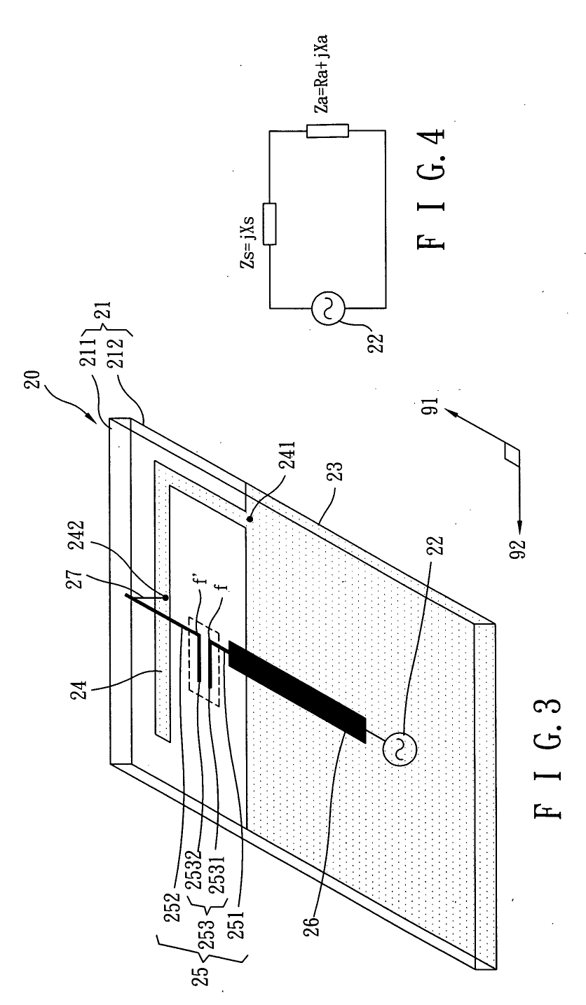

Thus the equivalent circuit of antenna device 20 of the invention can be viewed as the serial connection of impedance Zs and impedance Za as shown in FIG. 4 which depicts a diagram showing the input impedance equivalent circuit of the inverted F antenna according to the invention shown in FIG. 3. We can obtain expected imaginary part impedance value through proper design of the width and length of coupled lines 2531, 2532, and gap in between. If this imaginary part value Xs and the imaginary part of input impedance of antenna device 20 Xa can eliminate each other (Xs=−Xa), the system circuit will obtain good matching. Through the design of a coupling feedline 25 in this invention, we can improve the matching and bandwidth of antenna from the antenna itself. As such, the present invention does not require the setup of a matching circuit on the system circuit board against the “imaginary part of antenna impedance”, hence offering the advantages of simpler design, lower cost, and space saving.

The other embodiments of the invention described below have identical or similar elements to those described earlier. Those elements are assigned the same names and numeral if they are exactly identical. Similar elements are assigned the same names and numeral with only an English letter suffix for distinction purpose, and their detailed constitutions will not be elaborated.

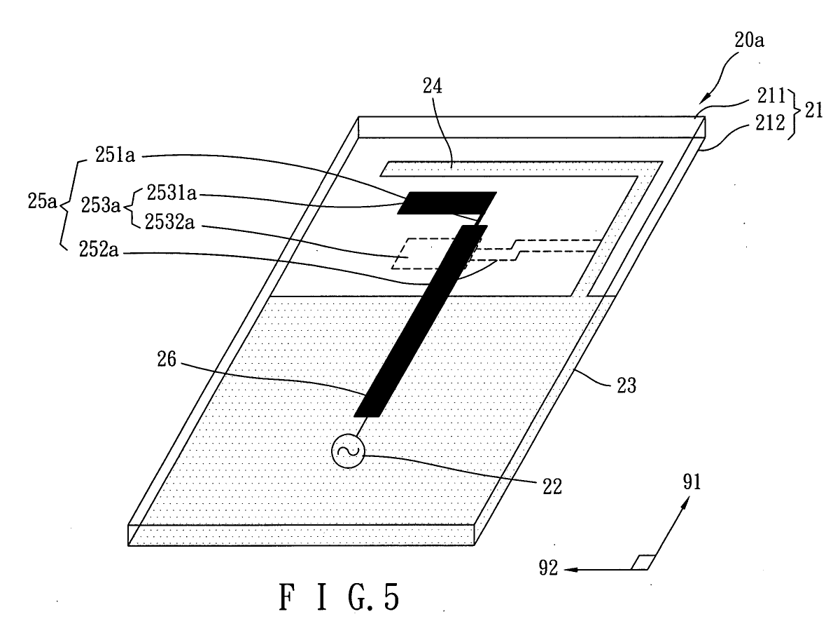

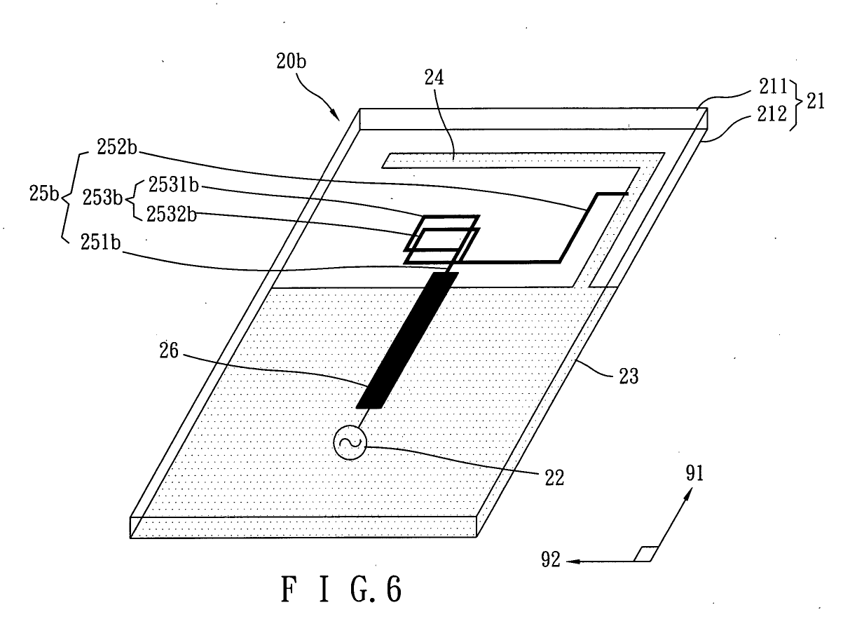

FIG. 5 is a perspective view of a coupled-fed antenna 20a according to a second embodiment of the invention. In the second embodiment, the coupled-fed antenna 20a similarly comprises: a substrate 21, a signal source 22, a ground plane 23, a radiation conductor 24, and a coupling feedline 25a. As shown in FIG. 5, the second embodiment of antenna 20a differs from the first embodiment in a way that the first feedline 251a of the coupling feedline 25a is situated on the first surface 211, while the second feedline 252a is provided on the second surface 212. In addition, the coupling element 253a consists of two short coupled lines 2531a, 2532a disposed respectively on the first surface 211 and the second surface 212, wherein short coupled line 2531a is connected to the first feedline 251a, and short coupled line 2532a is connected to the second feedline 252a. The projections of short coupled lines 2531a, 2532a in the direction perpendicular to the first surface 211 are at least partially overlapped. In the second embodiment, the two short coupled lines 2531a, 2532a are parallel to each other and can be of the same or different sizes (one big, one small).

FIG. 6 is a perspective view of a coupled-fed antenna 20b according to a third embodiment of the invention. In the third embodiment, the coupled-fed antenna 20b similarly comprises: a substrate 21, a signal source 22, a ground plane 23, a radiation conductor 24, and a coupling feedline 25b. As shown in FIG. 6, the third embodiment of antenna 20b differs from the second embodiment in a way that the two short coupled lines 2531b, 2532b of the coupling element 253b have hollow ring structure. This hollow ring can be of square, round or other geometric shape. The sizes and shapes of the two coupled lines 2531b, 2532b can be identical or different.

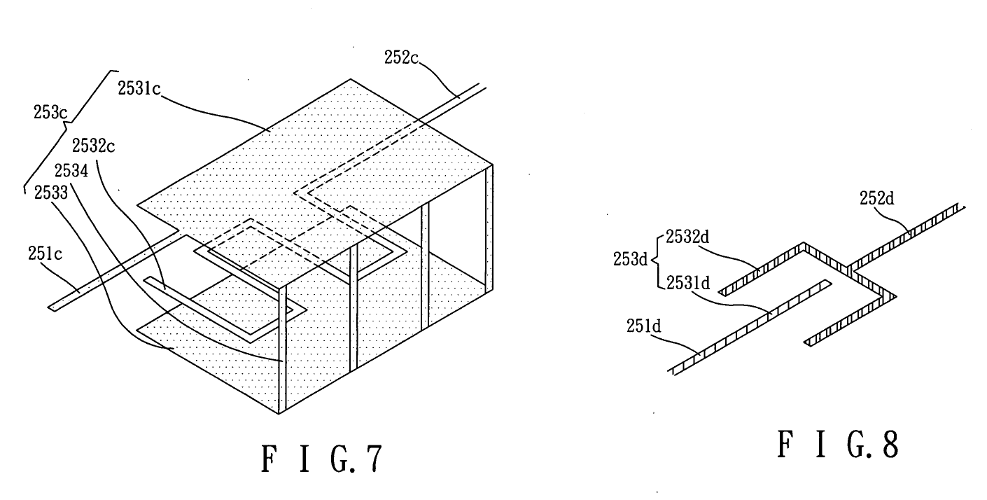

FIG. 7 is a perspective view of a coupled-fed antenna 20c according to a fourth embodiment of the invention. As shown in FIG. 7, this fourth embodiment differs from the aforementioned embodiments in a way that its substrate further contains a third surface (not shown in the figure), and its coupling element 253c further consists of: a first coupled line 2531c situated on the first surface 211 and connected to the first feedline 251c, a second coupled line 2532c situated on the second surface 212 and connected to the second feedline 252c, a third coupled line 2533 situated on the third surface, and at least a lead 2534 that runs through first surface and third surface to connect the first and the third coupled lines 2531c, 2533. The projections of coupled lines 2531c, 2532c, 2533 in the direction perpendicular to the first surface 211 are at least partially overlapped. The first coupled line 2531c and the third coupled line 2533 are flat in shape, while the second coupled line 2532c has multiple bends in something like a S shape.

FIG. 8 is a perspective view of a coupled-fed antenna 20d according to a fifth embodiment of the invention. As shown FIG. 8, this fifth embodiment differs from the aforementioned embodiments in a way that its coupling element 253d consists of: a C-shaped coupled line 2532d with an opening, and a short coupled line 2531d arranged in the opening of C-shaped coupled line 2532d without contacting it. One of the two coupled lines 2531d, 2532d is connected to the first feedline 251d, while the other coupled line is connected to the second feedline 252d.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A coupled-fed antenna device, comprising:
a substrate having at least a first surface and a second surface, which are defined with a first direction and a second direction perpendicular to each other thereon;
a signal source disposed on the first surface of substrate to provide wireless communication signals;
a ground plane which is electrically grounded and covers at least a partial area on the second surface of substrate;
a radiation conductor disposed on the second surface of substrate which extends a predetermined first length from the ground plane generally towards the first direction and then turns generally towards the second direction and extends a predetermined second length; and
a coupling feedline connecting the signal source and the radiation conductor, and consisting of at least a first feedline and a second feedline coupled together without contacting each other.

2. The antenna device according to claim 1, wherein said antenna is an inverted F antenna.

3. The antenna device according to claim 1, wherein the projection of said signal source in the direction perpendicular to the first surface is covered by the ground plane on the second surface.

4. The antenna device according to claim 3, wherein the projection of first feedline in the direction perpendicular to the first surface is not covered by the ground plane on the second surface, and the signal source is connected to an end of first feedline through a signal transmission line.

5. The antenna device according to claim 1, wherein one end of said second feedline is connected to a predetermined attachment point on the radiation conductor.

6. The antenna device according to claim 5, wherein the real part of input impedance of said antenna device is adjusted by moving the position of said attachment point.

7. The antenna device according to claim 5, wherein said first feedline and second feedline are coupled together by a coupling element and said coupling element is substantially serially connected between the signal source and the attachment point.

8. The antenna device according to claim 7, wherein the imaginary part of input impedance of said antenna device is adjusted by altering the input impedance of an open stub of said coupling element.

9. The antenna device according to claim 7, wherein the coupling element consists of two adjoining short coupled lines parallel to each other with one short coupled line connecting to the first feedline and the other connecting to the second feedline.

10. The antenna device according to claim 7, wherein said coupling element consists of a C-shaped coupled line with an opening and a short coupled line arranged in the opening of C-shaped coupled line without contacting it, wherein one of the two coupled lines is connected to the first feedline and the other is connected to the second feedline.

11. The antenna device according to claim 7, wherein said first feedline is situated on the first surface and said second feedline is situated on the second surface.

12. The antenna device according to claim 11, wherein said coupling element is made of two short coupled lines disposed on the first surface and the second surface respectively, wherein one short coupled line is connected to the first feedline and the other is connected to the second feedline, and the projections of the two short coupled lines in the direction perpendicular to the first surface are at least partially overlapped.

13. The antenna device according to claim 12, wherein the two short coupled lines are in hollow ring structure.

14. The antenna device according to claim 11, wherein said substrate further contains a third surface and said coupling device consists of: a first coupled line disposed on the first surface and connected to the first feedline; a second coupled line disposed on the second surface and connected to the second feedline, a third coupled line disposed on the third surface; and at least a lead running through the first and the third surfaces to connect the first and the third coupled lines; wherein the projections of those coupled lines in the direction perpendicular to the first surface are at least partially overlapped.

15. The antenna device according to claim 14, wherein said first coupled line has a flat shape, and the second coupled line has multiple bends in a shape similar to a S curve.

16. A coupled-fed antenna device, comprising:
a substrate having at least a first surface and a second surface;
a signal source disposed on the first surface of substrate to provide wireless communication signals;
a ground plane which is electrically grounded and covers at least a partial area on the second surface of substrate;
a radiation conductor disposed on the second surface of substrate;
a first feedline with one end connected to the signal source;
a second feedline with one end connected to a predetermined attachment point on the radiation conductor; and
a coupling element consisting of at least two coupled lines coupled together without contacting each other, wherein one coupled line is connected to the other end of first feedline and the other coupled line is connected to the other end of second feedline such that the coupling element is substantially serially connected between the signal source and the attachment point.

17. The antenna device according to claim 16, wherein the surfaces of the substrate are defined with a first direction and a second direction perpendicular to each other thereon, and the radiation conductor extends a predetermined first length from the ground plane generally towards the first direction and then turns generally towards the second direction and extends a predetermined second length to render the antenna device substantially an inverted F antenna.

18. The antenna device according to claim 16, wherein the real part of input impedance of said antenna device is adjusted by moving the position of said attachment point; and the imaginary part of input impedance of said antenna device is adjusted by altering the input impedance of an open stub of said coupling element.
